(19) United States
(12) Patent Application Publication
(10) Pub. No.: US 2013/0054472 A1
(43) Pub. Date: Feb. 28, 2013

(54) SYSTEM AND METHOD OF WIRELESSLY DOWNLOADING DIGITAL MEDIA ITEMS

(71) Applicant: Barrie Clark, Dundee (GB)

(72) Inventor: Barrie Clark, Dundee (GB)

(73) Assignee: NCR CORPORATION, Duluth, GA (US)

(21) Appl. No.: 13/222,068

(22) Filed: Aug. 31, 2011

(51) Int. Cl. G06Q 20/00; G06F 15/16

(52) U.S. Cl. 705/71; 709/219

(57) ABSTRACT

A system and method of wirelessly downloading digital media items which automatically downloads the digital media items to portable communication devices in environments where users are engaged with other activities. An example system includes a network including a wireless network defining a zone of coverage, and a server. The server stores locked digital media items, establishes an account for a digital media customer, automatically downloads selected locked digital media items to a portable communication device of the customer when the customer has brought the portable communication device within the zone of coverage and the portable communication device is connected to the server through the wireless network, processes payment from the customer for a number of downloaded locked digital media items, and provides keys for unlocking the number of downloaded locked digital media items.

### BACKGROUND

The compact disk (CD) and digital video disk (DVD) are leading portable digital media storage devices. Hundreds of millions of disks are produced each year. These disks are used to store digital media files including, but not limited to movies, television shows, music, music videos, video game software, electronic books, and a wide array of additional file types and file formats.

Consumers may rent or purchase media disks from kiosks. While kiosks have improved availability of digital media items and provided the convenience of self-service operation, kiosk solutions for delivering digital media items may be expensive. Further, there may be bottlenecks when multiple potential users are unable to obtain their desired digital media items quickly enough. When consumers are actively involved in obtaining digital media items, they may become impatient.

Portable computing devices with wireless communication, such as smart phones, tablets, and laptops offer users the convenience of downloading, storing, transporting, and playing digital media items. More and more potential media consumers carry portable computing devices.

Consumers are often in locations where they spend time engaged in activities, sometimes for an extended period of time.

Therefore, it would be desirable to provide a system and method of wirelessly downloading digital media items which completes the downloading while consumers are engaged with other activities.

### SUMMARY

A system and method of wirelessly downloading digital media items is provided.

An example system includes a network including a wireless network defining a zone of coverage, and a server. The server is for storing locked digital media items, for establishing an account for a digital media customer, for automatically downloading selected locked digital media items to a portable communication device of the customer when the customer has brought the portable communication device within the zone of coverage and the portable communication device is connected to the server through the wireless network, for processing payment from the customer for a number of downloaded locked digital media items, and for providing keys for unlocking the number of downloaded locked digital media items.

An example method includes establishing an account for a digital media customer, automatically downloading selected locked digital media items to a portable communication device of the customer by a server when the customer has brought the portable communication device within a zone of coverage of a wireless network and the portable communication device is connected to the server through the wireless network, processing payment from the customer for a number of downloaded locked digital media items by the server, and providing keys for unlocking the number of downloaded locked digital media items by the server.

### BRIEF DESCRIPTION OF THE DRAWINGS

FIG. 1 is a block diagram of an example system for wirelessly downloading digital media items.

FIG. 2 illustrates an example embodiment of the system for wirelessly downloading digital media items configured for a cinema location;

FIG. 3 illustrates an example embodiment of the system for wirelessly downloading digital media items configured for a retail store location;

FIG. 4 illustrates an example embodiment of the system for wirelessly downloading digital media items configured for an airport location;

FIG. 5 is a flow diagram illustrating one example method of downloading digital media items.

FIG. 6 is a flow diagram illustrating another example method of downloading digital media items.

### DETAILED DESCRIPTION

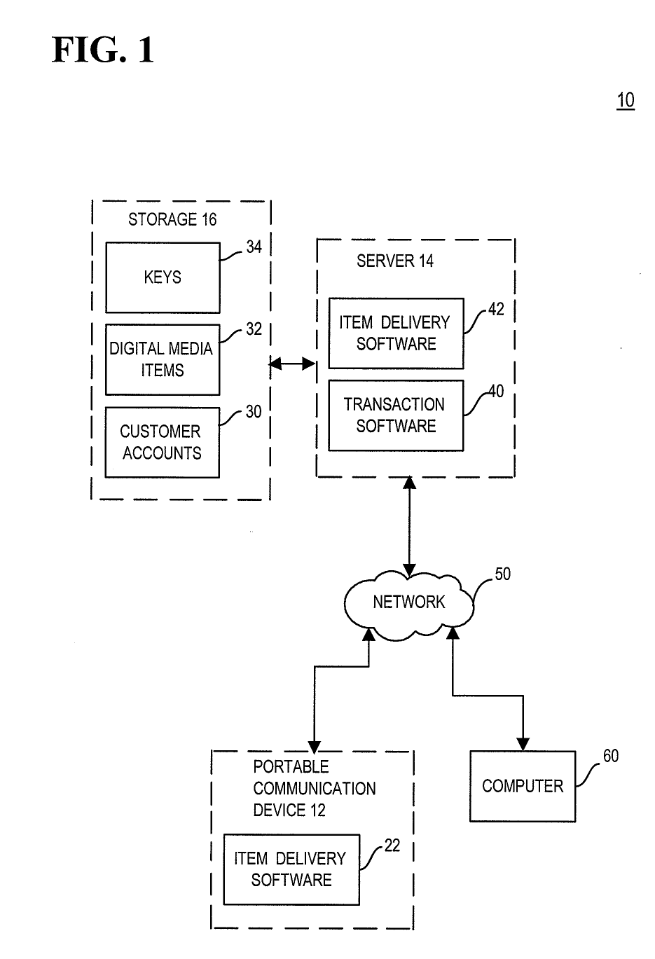

Referring now to FIG. 1, one example system 10 includes portable communication device 12, server 14, and storage 16.

Portable communication device 12 downloads digital media items 32 from server 14 and stores them. Server 14 includes a library of digital media items 32.

Portable communication device 12 may include a smart phone, tablet, laptop, netbook, or other type of portable computing device with one or types of wireless communication circuitry and sufficient storage capacity. As such, portable communication device 12 may not only be able to download digital media items 32 and store them, but also view or play them.

The wireless communication circuitry may include standard wireless networking (IEEE 802.11 standard or “Wifi”), cellular communications circuitry, and 60 GHz wireless networking. The 60 GHz wireless networking is particularly suited for downloading digital media items 32, because it is capable of transferring data at speeds up to about three gigabits per second. At these speeds, server 14 may be able to transfer a movie in digital video disk (DVD) format in a few seconds and a movie in Blu-ray dual-layer format in under a minute. Other communication methods are also envisioned.

Alternative embodiments are also envisioned in which portable communication device 12 includes a smart phone, a tablet, or other portable computing device which is not already equipped with a particular type of wireless communication circuitry necessary for downloading digital media items 32. For example, many smart phones may not be equipped with 60 GHz wireless networking capability. In this case, additional wireless communication circuitry may be coupled to the smart phone through a dongle or other cable attached to a communication port of the smart phone.

Network 50 may include any combination of wired or wireless networks and may include a global communication network, also known as the Internet. For example, network 50 may include one or more access points that establish one or more zones of coverage. The number of network access points may be determined by a desired coverage area and bandwidth.

Portable communication device 12 may additionally include a processor, memory for program and data storage, a display, an input device, a communication port, such as a universal serial bus (USB) port, and additional types of communication circuitry. For example, portable communication device 12 may additionally include Bluetooth communications circuitry.

The processor may execute an operating system and application software. For example, portable communication device 12 may execute item delivery software 22 for facilitating receiving and storing digital media items 32 from server 14. If portable communication device 12 is a smart phone, item delivery software 22 may include a software applet written to be executed within the operating system of the smart phone.

Portable communication device 12 may further execute software for playing digital media items 32 or sending digital media items 32 to a television or display for viewing or playing.

In one example embodiment, portable communication device 12 “pulls” one or more digital media items 32 from server 14. Item delivery software 22 automatically detects when portable communication device 12 is in range of network 50, for example, connected to network 50, and automatically downloads digital media items 32 previously selected by a user or determined by user preferences stored within portable communication device 12 or determined by server 14 from the customer profile in customer account 30.

The term “automatically” as used herein describes events which are essentially independent of conscious customer control.

In another example embodiment discussed in more detail below, portable communication device 12 may passively receive digital media items 32 from server 14.

Customers establish accounts 30 with a provider in order to receive digital media files 32 via either embodiment. A user may establish a customer account 30 by connecting to server 14 through network 50. For example, the user may use computer 60 to connect to server 14 through network 50. Customers can enroll and select preferences at a provider web site hosted by server 14. Computer 60 may include, for example, a personal computer, smart phone, provider kiosk, or other computing device.

Customer accounts 30 may include customer profiles with customer preferences for digital media items 32. After establishing account 30, a customer can select and store preferences for digital media items 32. For example, customers may express an interest in particular movie genres, certain actors, recent releases, or the like.

Server 14 executes transaction software 40. Transaction software 40 processes payment for digital media items 32 or keys 34 for unlocking digital media items 32. A customer reviews downloaded digital media items 32 and connects to server 14 through network 50 to select some or all for payment. The customer then completes payment based upon the selections.

Following receipt of payment, transaction software 40 sends keys 34 or makes corresponding keys 34 available for downloading via network 50. Keys 34 serve to unlock digital media items 32 so that they can be viewed or played.

For example, digital media items 32 may be delivered in encrypted form. Keys 34 may include the decryption keys for decrypting digital media items 32.

Digital media items 32 which are not paid for cannot be unlocked for viewing or playing and remain dormant. A customer may later obtain keys 34 for these items, manually delete these items, or portable communication device 12 via item delivery software 22 may be configured to automatically delete these items after a predetermined time period.

In accordance with the other example embodiment, server 14 may automatically provide or “push” one or more digital media items 32 from storage 16 to portable communication device 12. Hybrid “push” and “pull” arrangements are also envisioned.

In support of the push method of delivery, server 14 additionally executes item delivery software 42, which automatically determines when portable communication device 12 is within communication range and determines identification information associated with portable communication device 12. Portable communication device 12 provides a unique identifier to server 14, such as a Media Access Control (MAC) address.

Item delivery software 42 also automatically selects one or more digital media items 32 to deliver to portable communication device 12. Item delivery software 42 uses the identification information provided by portable communication device 12 to access a corresponding customer account 30 previously established by a user of portable communication device 12. Item delivery software 42 uses the information in customer account 30 to select digital media items 32 for delivery.

Item delivery software 42 may take into account more than just customer preferences. For example, item delivery software 42 may store and analyze purchase histories of customers, including those of other customers, to update individual customer profiles.

Item delivery software 42 also automatically delivers digital media items 32 to portable communication device 12. If item delivery software 42 is unable to deliver digital media items 32, for example, if delivery is interrupted by portable communication device 12 leaving the zone of coverage, item delivery software 42 stops delivery until item delivery software 42 determines that portable communication device 12 has reentered the zone of coverage. Thus, item delivery software 42 is capable of multiple session delivery.

Following delivery, item delivery software 42 may automatically deliver a message to alert the customer, such as a text message via simple message service (SMS) or an electronic mail (email) message, using address information in customer account 30.

Example server 14 includes a processor, memory, and program and data storage. The processor may execute an operating system such as a Microsoft operating system. Server 14 may include a web server and provide a web page which is downloadable to portable computer device 12 and/or computer 60 to setup and maintain customer accounts 30, to complete selection and payment for downloaded digital media items 32, and to download keys 34.

Server 14 may include one or more networked computers and may be combined with or separate from storage 16. For example server 14 may represent one or more on-premise servers at a location where digital media files 28 are downloaded and one or more remote servers coupled to the on-premise servers through network 50.

System 10 enables providers including transaction establishments or businesses with additional sales and marketing opportunities and provides customers with the ability to download digital media files 32 while they are engaged with other activities. It is also envisioned that system 10 may be deployed in non-business venues as well, venues that offer no other goods or services for sale other than digital media items 32.

For example, system 10 may be used in businesses such as theaters, cinemas, airports, groceries, shopping malls, stadiums, hospitals, car repair facilities, and other commercial venues. Customers may download digital media items 32 while they are watching movies, waiting for airplanes, shopping, waiting for a doctor, and waiting for a car to be repaired.

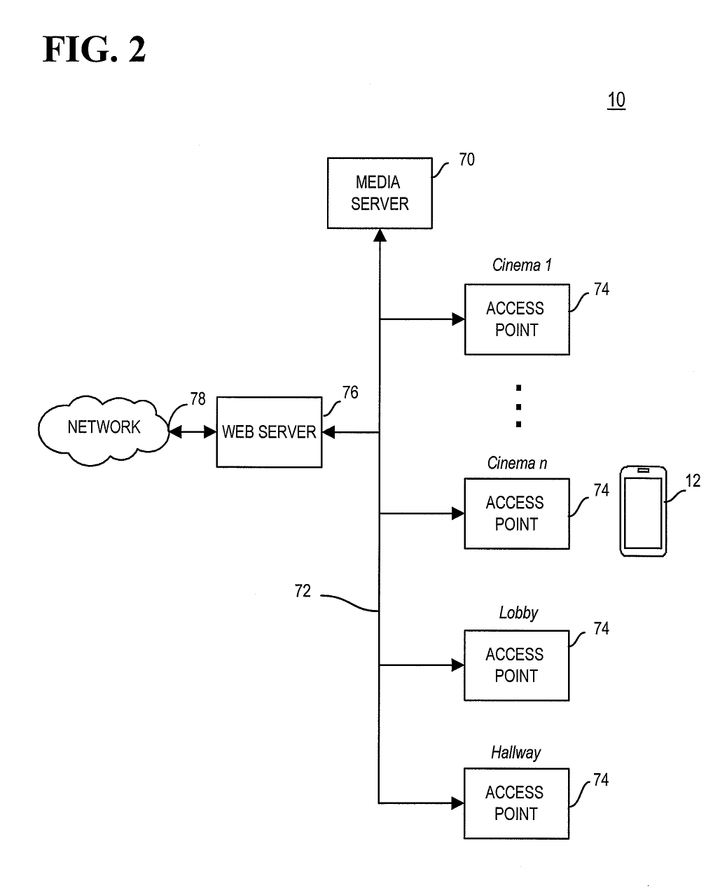

FIG. 2 illustrates an example embodiment of system 10 within a cinema establishment. The cinema establishment is divided into a plurality of different cinemas for viewing movies, a lobby, one or more hallways connecting the lobby to the different cinemas, and possibly other sections.

This example embodiment includes a media server 70 and one or more network access points 74 connected to media server 70 via network 72.

Media server 70 stores digital media items 32. Movie studios, such as Sony, Warner Brothers, Fox and the like provide digital media items 32 to cinema establishments. Digital media items 32 may include movies being shown in the cinema establishment and other movies available for download.

The number of network access points may be determined by desired coverage area and bandwidth. For example, one or more network access points 74 may be installed in each cinema, in the lobby, and in the hallways. Network 72 and access points 74 may be advantageously designed to hand off a moving portable device 12 from one access point 74 to another as a customer moves through the cinema establishment.

Network access points 74 may be compatible with one or more different communication standards, such as Wifi and 60 GHz standards.

Movie goers may enroll at any time, including after entering one of the cinemas, by connecting to an enrollment page hosted by web server 76.

Movie goers, if enrolled or opted-in, may receive unsolicited digital media items 32 to their portable communication devices 12 while waiting in the lobby, walking through a hallway, or viewing a movie in one of the cinemas.

Movie goers may download keys 34 through network 72 or wait till after they have left the cinema establishment by connecting to web server 76 through network 78. Network 78 may include any combination of wired or wireless networks and may include a global communication network, also known as the Internet.

Movie goers may find the added capability of downloading digital media items 32 to be convenient in many additional ways. For example, after viewing coming attractions at one of the cinemas 74, or movies not yet released for sale to the general public, a customer with portable communication device 12 may download a digital media item 32 corresponding to one of the coming attractions and later obtain key 34 when the movie is released for sale to the general public.

As another example, a customer may download an alternative ending to a movie along with promotional material tied to a key 34 for unlocking the alternative ending. After portable communication device 12 plays the promotional material, portable communication device 12 uses key 34 to unlock the alternative ending.

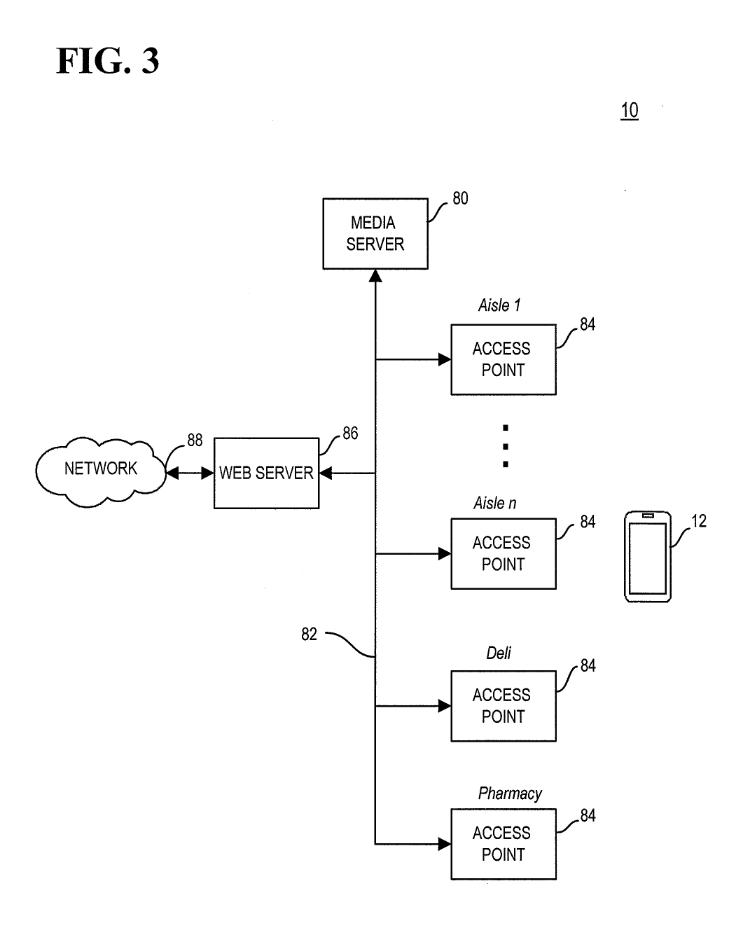

Turning to FIG. 3, another example embodiment of system 10 is located in a grocery, retail, auto repair, tire or other store, superstore, or mall where people spend time shopping. An example store includes different areas including aisles between shelves, a delicatessen area, a pharmacy area, and possibly other sections.

This example embodiment shares some of the features of the previous example embodiment. System 10 includes a media server 80 and one or more network access points 84 connected to media server 80 via network 82.

An example installation includes one or more network access points 84 in each aisle, in the delicatessen, and in the pharmacy.

Shoppers may enroll at any time, including after entering the store, by connecting to an enrollment page hosted by web server 86.

Shoppers, if enrolled or opted-in, may receive unsolicited digital media items 32 to their portable communication devices 12 while shopping or waiting at the delicatessen or pharmacy.

Shoppers may download keys 34 through network 82 or wait till after they have left the store by connecting to web server 86 through network 88. Network 88 may include any combination of wired or wireless networks and may include a global communication network, also known as the Internet.

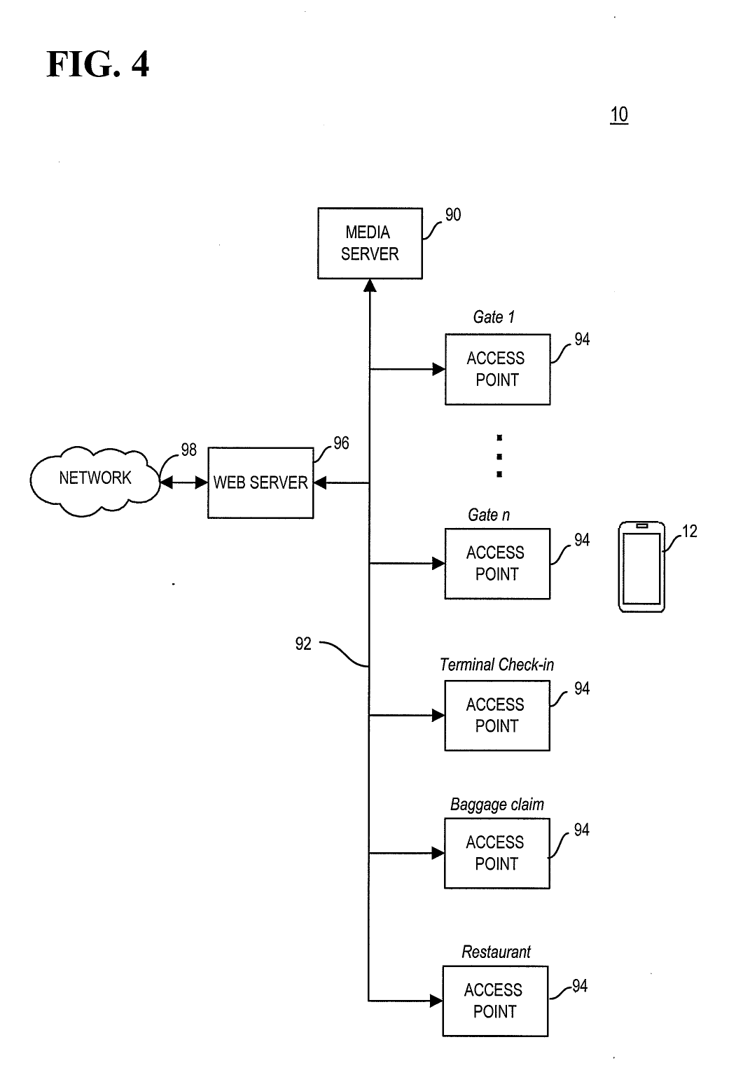

Turning to FIG. 4, another example embodiment of system 10 is located in an airport where people spend time waiting for flights and moving from one gate to another. An example airport includes different areas including terminal check-in and baggage claim, gates, and restaurants and other business establishments.

This example embodiment shares some of the features of the previous example embodiments. System 10 includes a media server 90 and one or more network access points 94 connected to media server 90 via network 92.

An example installation includes one or more network access points 94 in each terminal check-in, baggage claim, and gate area, and in each business establishment within each concourse.

Travelers may enroll at any time, including after entering the airport, by connecting to an enrollment page hosted by web server 96.

Travelers, if enrolled or opted-in, may receive unsolicited digital media items 32 to their portable communication devices 12 while moving with the airport or waiting for check-in, flights, or baggage, or conducting business at restaurants and shops.

Travelers may download keys 34 through network 92 or wait till after they have left the airport by connecting to web server 86 through network 98. Network 98 may include any combination of wired or wireless networks and may include a global communication network, also known as the Internet.

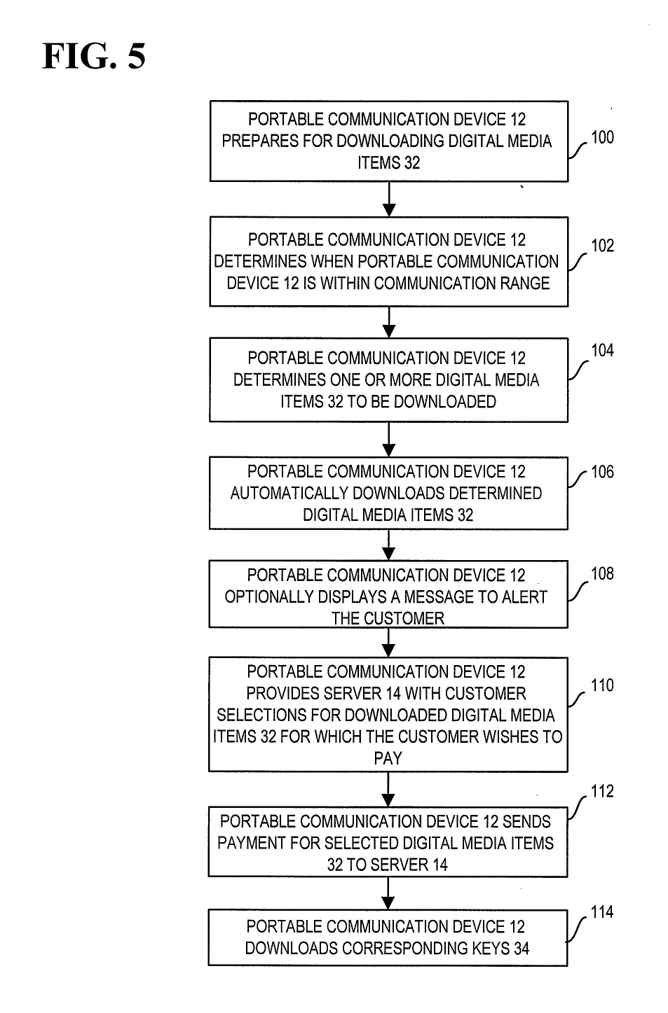

With reference to FIG. 5, a method of downloading digital media items 32 is illustrated. This method envisions automatically providing or “pulling” one or more digital media items 32 from storage 16 to portable communication device 12.

In step 100, portable communication device 12 via item delivery software 22 prepares for downloading digital media items 32. This may include connecting to a provider web site to establish account 30 and/or provide an indication that the customer has opted-in to receiving digital media files 32.

In step 102, portable communication device 12 via item delivery software 22 determines when portable communication device 12 is within communication range. This may include determining that portable communication device 12 is connected to network 50.

In step 104, portable communication device 12 via item delivery software 22 determines one or more digital media items 32 to be downloaded. This may include using customer selections or customer preferences in portable communication device 12 to select digital media items 32 for download.

In step 106, portable communication device 12 via item delivery software 22 signals server 14 to automatically download digital media items 32 to portable communication device 12. This may include uploading a list of digital media items 32 for download.

In step 108, portable communication device 12 via item delivery software 22 may optionally display a message to alert the customer.

In step 110, portable communication device 12 provides server 14 with customer selections for digital media items 32 for which the customer wishes to pay. This may include connecting to a provider web site through network 50, logging-into the customer account 30, reviewing a list of the downloaded media items 32, and marking those for which the customer wishes to pay.

In step 112, portable communication device 12 sends payment for selected digital media items 32. This may include sending payment instructions from the customer while the customer is logged-in to the provider web site.

In step 114, portable communication device 12 downloads corresponding keys 34. This may include downloading keys 34 while the customer is logged-in to the provider web site. The customer may also log in later during a different session to download keys 34.

The customer uses keys 34 to unlock digital media items 32 for viewing or playing.

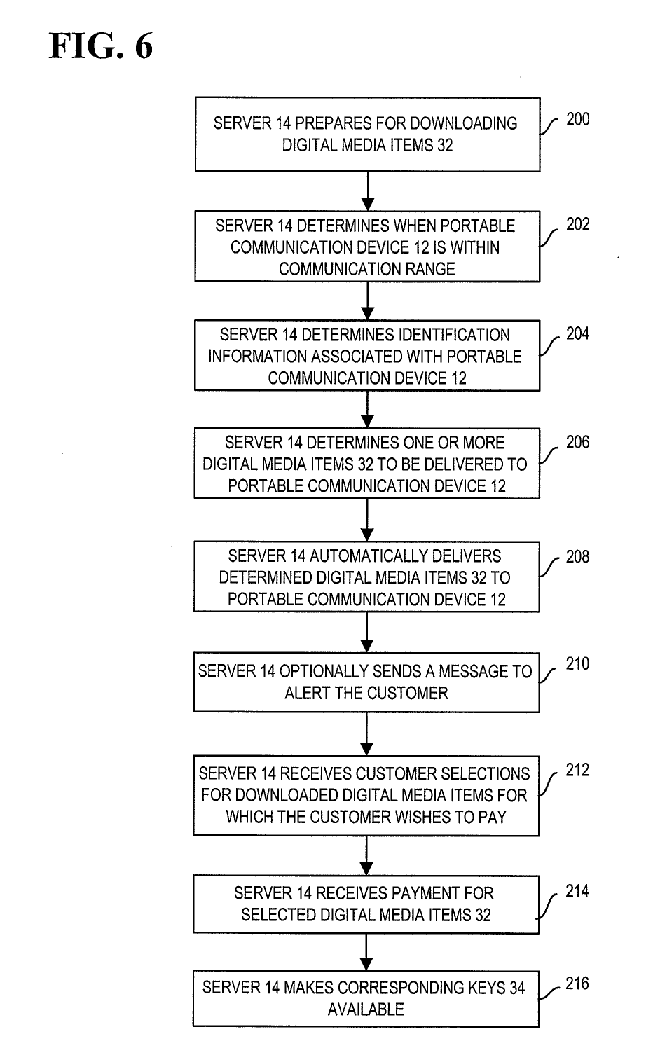

With reference to FIG. 6, another method of downloading digital media items 32 is illustrated. This method envisions automatically providing or “pushing” one or more digital media items 32 from storage 16 to portable communication device 12.

In step 200, server 14 via item delivery software 42 establishes prepares for downloading digital media items 32. This may include establishing an account 30 on behalf of a customer and/or receiving an indication that the customer has opted-in to receiving digital media files 32.

In step 202, server 14 via item delivery software 42, determines when portable communication device 12 is within communication range. This may include determining that portable communication device 12 is connected to network 50.

In step 204, server 14 via item delivery software 42 determines identification information associated with portable communication device 12. This may include obtaining a MAC address from portable communication device 12.

In step 206, server 14 via item delivery software 42 determines one or more digital media items 32 to deliver to portable communication device 12. This may include using the identification information provided by portable communication device 12 to access corresponding customer account 30, and using the information in customer account 30, such as customer preferences and customer purchase history, to select digital media items 32 for delivery.

In step 208, server 14 via item delivery software 42 automatically delivers digital media items 32 to portable communication device 12.

In step 210, server 14 via item delivery software 42 may optionally send a message to alert the customer, such as a text message via simple message service (SMS) or an electronic mail (email) message, using address information in customer account 30.

In step 212, server 14 via transaction software 40 receives customer selections for digital media items 32 for which the customer wishes to pay. This may include connecting to a provider web site through network 50, logging-into the customer account 30, reviewing a list of the downloaded media items 32, and marking those for which the customer wishes to pay.

In step 214, server 14 via transaction software 40 receives payment for selected digital media items 32. This may include receiving payment instructions from the customer while the customer is logged-in to the provider web site.

In step 216, server 14 via transaction software 40 makes corresponding keys 34 available for download. This may include making keys 34 available for download while the customer is logged-in to the provider web site. The customer may also log in later during a different session to download keys 34.

The customer uses keys 34 to unlock digital media items 32 for viewing or playing.

Although particular reference has been made to certain embodiments, variations and modifications are also envisioned within the spirit and scope of the following claims. It will be recognized that the features of system 10 may be adapted to other locations and contexts where people spend time waiting, such as a sports stadium or arena, a restaurant, gas pump, building lobby, a bowling alley, a doctor's waiting room, a government office such as a driver's license bureau or social security office. In all these cases, as well as others, an opportunity to market a product, such as a movie, an electronic book, or music may be integrated with the opportunity for providing other business related information or marketing materials.

1. A system for wireless downloading of digital media items comprising:
a network including a wireless network defining a zone of coverage; and
a server for storing locked digital media items, for establishing an account for a digital media customer, for automatically downloading selected locked digital media items to a portable communication device of the customer when the customer has brought the portable communication device within the zone of coverage and the portable communication device is connected to the server through the wireless network, for processing payment from the customer for a number of downloaded locked digital media items, and for providing keys for unlocking the number of downloaded locked digital media items.

2. The system of claim 1 wherein the wireless network comprises an access point capable of downloading the selected locked digital media items at a rate of at least 3 Gb/s.

3. The system of claim 1 wherein the server is also for determining that the portable communication device has left the zone of coverage and ceasing delivery of the selected locked digital media items until the portable communication device returns to the zone of coverage.

4. The system of claim 1 wherein the server is also for selecting the locked digital media items to deliver based upon stored customer preferences associated with the account.

5. The system of claim 1 wherein the server is also for selecting the locked digital media items to deliver based upon digital media items previously purchased by the customer.

6. The system of claim 1 wherein the server processes the payment when the portable communication device is outside the zone of coverage.

7. The system of claim 1, wherein the zone of coverage is within a business establishment that sells goods or services in addition to the digital media items.

8. The system of claim 1, wherein the server is also for detecting when the portable communication device is within the zone of coverage and initiating downloading of the locked digital media items in response to the detection of the portable communication device.

9. The system of claim 1, wherein the server is also for receiving a command from the portable communication device and initiating downloading of the locked digital media items in response to the command.

10. A system for wireless downloading of digital media items comprising:
a network including a wireless local area network defining a zone of coverage within a business establishment that sells goods or services and the digital media items; and
a server for storing locked digital media items, for storing records of customers who have opted-in to receive the locked digital media items to portable communication devices, for storing customer preferences associated with the records, for detecting the portable communication devices within the zone of coverage, for selecting some of the locked digital media items for delivery to the portable communication devices based upon the customer preferences, for automatically downloading selected locked digital media items to the portable communication devices while the portable communication devices are within the zone of coverage, for processing payment for a number of downloaded locked digital media items from the customers, and for providing keys for unlocking the number of locked downloaded digital media items.

11. A portable communication device comprising:
wireless communication circuitry for connecting to a wireless local area network when the wireless communication circuitry is within a zone of coverage of the wireless local area network; and
a processor for automatically sending a message containing a selection of digital media items to a server through the wireless local area network, for automatically downloading and storing selected digital media items in a locked condition while the wireless communication circuitry is within the zone of coverage, for sending payment for a number of downloaded digital media items to the server, and for receiving keys for unlocking the number of downloaded digital media items from the server.

12. The device of claim 11 wherein the wireless communication circuitry is capable of downloading the selected digital media items at a rate of at least 3 Gb/s.

13. A method of wirelessly downloading a digital media item comprising:
establishing an account for a digital media customer;
automatically downloading selected locked digital media items to a portable communication device of the customer by a server when the customer has brought the portable communication device within a zone of coverage of a wireless network and the portable communication device is connected to the server through the wireless network;
processing payment from the customer for a number of downloaded locked digital media items by the server; and
providing keys for unlocking the number of downloaded locked digital media items by the server.

14. The method of claim 13, wherein the downloading step comprises downloading the selected locked digital media items at a rate of at least 3 Gb/s.

15. The method of claim 13, further comprising:
determining that the portable communication device has left the zone of coverage; and
ceasing delivery of the selected locked digital media items until the portable communication device returns to the zone of coverage.

16. The method of claim 13, further comprising selecting the locked digital media items to deliver based upon stored customer preferences associated with the account.

17. The method of claim 13, further comprising selecting the locked digital media items to deliver based upon digital media items previously purchased by the customer.

18. The method of claim 13, wherein the processing step comprising processing the payment when the portable communication device is outside the zone of coverage.

19. The method of claim 13, further comprising providing the zone of coverage within a business establishment that sells goods or services in addition to the digital media items.

20. The method of claim 13, further comprising:
detecting when the portable communication device is within the zone of coverage; and
initiating downloading of the locked digital media items in response to the detecting step.

21. The method of claim 13, further comprising:
receiving a command from the portable communication device; and
initiating downloading of the locked digital media items in response to the receiving step.

22. A method of wirelessly downloading a digital media item comprising:
automatically sending a message containing a selection of locked digital media items to a server through a wireless local area network by a portable communication device when the portable communication device is within a zone of coverage of the wireless local area network;
automatically downloading and storing the locked digital media items from the server by the portable communication device;
sending payment for a number of downloaded locked digital media items to the server by the portable communication device; and
receiving keys for unlocking the number of downloaded locked digital media items from the server by the portable communication device.

23. The method of claim 23, further comprising establishing an account for a digital media customer by the portable communication device.

24. The method of claim 23, further comprising selecting the locked digital media items to deliver based upon customer preferences stored in the portable communication device.

25. The method of claim 23, wherein the processing step comprises processing the payment when the portable communication device is outside the zone of coverage.

26. The method of claim 23, wherein the zone of coverage is within a business establishment that sells goods or services in addition to the digital media items.

27. The method of claim 23, wherein the downloading step comprises receiving the locked digital media items at a rate of at least 3 Gb/s.

28. A method of wirelessly downloading a digital media item comprising:
storing locked digital media items;
storing records of digital media customers who have opted-in to receive the locked digital media items to portable communication devices;
storing customer preferences associated with the records;
detecting the portable communication devices within a zone of coverage of a wireless local area network within a business establishment that sells goods or services and the digital media items;
selecting some of the locked digital media items for delivery to the portable communication devices based upon the customer preferences;
automatically downloading selected locked digital media items to portable communication devices of the customers by a server when the customers have brought the portable communication devices within the zone of coverage and the portable communication devices are connected to the server through the wireless local area network;
processing payment from the customers for a number of downloaded locked digital media items by the server; and
providing keys for unlocking the number of downloaded locked digital media items by the server.
